(19) United States
(12) Patent Application Publication
(10) Pub. No.: US 2009/0003311 A1
(43) Pub. Date: Jan. 1, 2009

(54) Design and debugging of distributed real time telecommunication systems

(76) Inventors: Olivier B. Clarisse, DesPlaines, IL (US); Geoffrey E. Margrave, Naperville, IL (US); William H. Pyritz, Naperville, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/823,360

(22) Filed: Jun. 27, 2007

(51) Int. Cl. H04L 12/28

(52) U.S. Cl. 370/351

(57) ABSTRACT

An apparatus in one example has: a network having a plurality of interconnected nodes; each of the nodes having a respective local reporter daemon and a storage operatively coupled thereto; at least one of the nodes having an editor daemon; an event broadcast message that is originated by a respective software component in a respective node in which an event occurred, the event broadcast message being sent to all local reporter daemons; information related to the event stored in a respective storage of a respective node by a respective software component; reports sent by the local reporter daemons to the editor daemon, the reports containing information related to the occurrence of the event; and a news story formed by the editor daemon from the received information.

### TECHNICAL FIELD

The invention relates generally to telecommunication systems, and more particularly to a means of designing and debugging distributed real time telecommunication systems.

### BACKGROUND

A telecommunication system may consist of three basic elements, a transmitter that takes information and converts it to a signal, a transmission medium over which the signal is transmitted, and a receiver that receives the signal and converts it back into usable information. A collection of transmitters, receivers or transceivers that communicate with each other is known as a network. Today telecommunication systems may be very large and very complex. They are constantly being changed or expanded.

It is becoming increasingly difficult for telecommunication system providers to debug real time problems occurring in field installations of various portions, as well as, the entire telecommunication system. The distributed and heterogeneous nature of the systems today makes analysis and debugging extremely difficult. The problem is related to how the software is designed and constructed from the initial stages through deployment.

Thus, debugging real-time production software is very difficult. It is especially difficult in controlled production environments where problems may be reported days after their occurrence. The problems themselves may be intermittent or dependent on peculiar environmental conditions that are difficult to reproduce in a lab. Worse yet, most complex systems are built from many and diverse hardware components that make putting the details of the error together very difficult. Excessive detailed logging leads to performance degradation. Furthermore, sifting through the multiplicity of error logs on the various hardware components makes collecting the relevant data very difficult. The customer expects that reported problems will be resolved quickly with no disruption to their running systems. Support personnel must work with logs and other data produced by the system to resolve the problem as soon as possible. Many times the data necessary for debugging is not available or is not comprehensive enough to isolate the root cause.

In the prior art there are round robin techniques used to store application state data temporarily on a local hardware node, but there are no comprehensive approaches for “pulling together” the “stories” that exist across a heterogeneous real time distributed system.

Therefore, there is a need for an improved method and system for designing and debugging distributed real time telecommunication systems.

### SUMMARY

One implementation encompasses an apparatus. This embodiment of the apparatus may comprise: a network having a plurality of interconnected nodes; each of the nodes having a respective local reporter daemon and a storage operatively coupled thereto; each of the nodes having software components that report events and data, keyed by a story ID, to the storage during normal processing; at least one of the nodes having an editor daemon; an event broadcast message that is originated by the occurrence of an application defined event on a respective node, the event broadcast message being sent to all local reporter daemons; information related to the event collected by a respective local reporter daemon from a respective storage of a respective node; reports sent by the local reporter daemons to the editor daemon, the reports containing information related to the occurrence of the event; and a news story formed by the editor daemon from the received information.

Another implementation encompasses a method. This embodiment of the method may comprise: a software component identifying an occurrence of an event in a system having a plurality of interconnected nodes with the local reporter daemons and broadcasting a story ID to all local reporter daemons in the system, which corresponds to “when a newsworthy event occurs, dispatching reporters to a respective area of the event”; broadcasting, by the respective software component, a story ID to all local reporter daemons in the system, and forwarding, by each of the reporter daemons, collected information along with the story ID to an editor daemon on at least one of the nodes of the plurality of interconnected nodes, which corresponds to “through interviews and observations the reporters put together a set of facts that are collected into a news story”; collecting, editing, and interleaving, by the editor daemon, the collected information, which corresponds to “the news story is sent to an editor for approval and modifications”; and forming therefore a news story that describes the occurrence of the event, which corresponds to “the news story is reported on the air”.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts the steps of a news story metaphor for the present method and apparatus;

FIG. 2 depicts one embodiment of the present apparatus; and

FIG. 3 depicts one embodiment of the present method.

### DETAILED DESCRIPTION

Telecommunication systems field support teams, using existing system debugging methods, have difficulty debugging field problems in a timely and effective manner. This is in no small part due to the nature of how the application software reports and responds to failure conditions under normal field conditions. Further, support personnel have very limited means to extract critical call related events and states to aid in the identification of operational types of failures that may not be related to the system being observed.

Another related problem concerns the wide diversity of log files that exist in the system and their contents. When an error occurs, there is typically no automated way to collect the critical pieces of information from the various log files necessary to debug the problem. In many cases, log files will have “rolled over” by the time a support person gets the report of failure and then starts sorting through the various sources.

Developers have become accustomed to using traces in the application code to aid in debugging problems. Clearly, this mode of development is unrealistic and unrelated to the debugging of a real target system where multiple calls are taking place concurrently. The tracing overhead and the sheer volume of the generated data cannot be sustained in a real system under load.

Product viability and survivability depends on a system that can be debugged. In addition logs roll over in time. It is important that essential debugging information is gathered and saved before it is lost.

Embodiments according to the present method and apparatus provide one solution to designing and debugging distributed real time telecommunication systems. These embodiments address issues and provide a solution based on a news story metaphor.

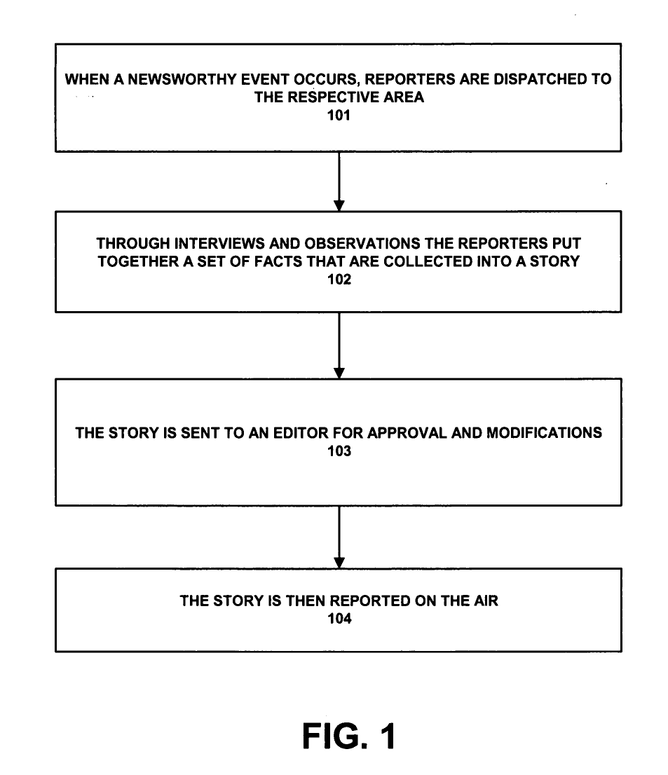

FIG. 1 depicts the steps of a news story metaphor. When a newsworthy event occurs, reporters are dispatched to the respective area (101). Through interviews and observations the reporters put together a set of facts that are collected into a story (102). The story provides a complete picture of what happened under the constraints of the known facts and time. The story is sent to an editor for approval and modifications (103) and then is reported on the air (104). The goal is for the story to provide a complete enough picture of what happened so that people watching the report for the first time can understand what happened and draw conclusions.

Embodiments according to the present method and apparatus may apply the news story metaphor to the problem of debugging distributed real-time production systems. In this context a system may be defined as a closed set of hardware nodes that are all interconnected. Software in this system may be written in such a way as to identify “stories” that occur during normal processing when a call is set up, a connection is made between two or more components, etc. When one of these stories begins, it is assigned a story ID that is unique across the system. All messages involved in the story contain the story ID, and all software components store the Story ID while processing the story. As part of processing the story, key events and associated data are reported by the software component and saved in storage. When a problem (or other user defined event) occurs, the application reports the event to all the “local reporters” (a daemon process running on each hardware node) running on the system using a broadcast message that includes the story ID. Each daemon process (local reporter) collects the facts on the story found on its hardware node (stored in the storage element as user defined key events) and forwards them to their “editor” (Global daemon process running on a designated hardware node). The “editor” collects, edits, and interleaves all the facts from the local reporters into a complete story that is “reported” to a log file. When a problem occurs, support personnel reference the news story for that problem and understand the events that led to the story.

Thus, in general the process of a story is extracted from the various nodes of a distributed real time telecommunication system that allow system providers to support the customer base in field applications.

When a newsworthy event occurs, reporters are dispatched to the area and through interviews and observations put together a set of facts that are collected into a story. The story provides a complete picture of what happened under the constraints of the known facts and time. The story is sent to an editor for approval and modifications and then is reported on the air. The goal is to provide a complete enough picture of what happened so that people watching the report for the first time can understand what happened and draw conclusions.

The news story metaphor is applied to the problem of debugging a production telecommunication system. The system is defined as a closed set of hardware nodes all inter-connected. Software in this system is written in such a way as to identify “stories” that occur during normal processing (e.g., a call is set-up, a connection is made between two or more components, etc.). When one of these stories begins, it is assigned a story ID that is unique across the system. All messages involved in the story contain the story ID, and all software components store the story ID while processing the story. Software components report user defined key events and data to the storage as they occur during normal processing. Unless a “news worthy” event occurs, the data in the storage will eventually be overwritten.

When a problem (or other user defined event) occurs, the application reports the event to all the “local reporters” (a daemon process running on each hardware node) running in the system with a broadcast message which includes the story ID. Each daemon process (local reporter) collects the facts on the story found on its hardware node (stored in the storage element as user defined key events) to their “editor” (global daemon process running on a designated hardware node). The “editor” collects, edits, and interleaves all the facts from the local reporters into a complete story that is “reported” to a log file. When a problem (or other user defined event) occurs, support personnel reference the associated news story and understand the events that surround the story.

As part of the reporting mechanism, controls are in place to limit the number of events reported by the application within a user specified time interval. The mechanism protects the system from being overloaded when a series of reportable events occur simultaneously.

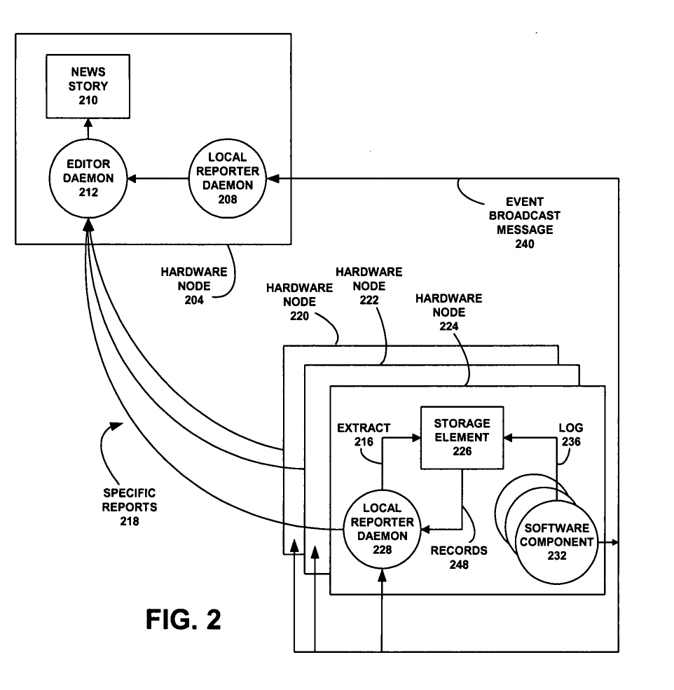

FIG. 2 depicts one embodiment of the present apparatus. The depicted embodiment in FIG. 2 may have a plurality of hardware boards 204, 220, 222, 224. These hardware boards 204, 220, 222, 224 may represent hardware nodes in a network. A hardware node may be, for example, various type of hardware entities where processing takes place. Typically, there may be communication between different software implementations running on different hardware boards 204, 220, 222, 224. The embodiments may not necessarily be restricted to one physical location, but may cover networks of different sizes that have been predetermined with physical boundaries.

Each of the hardware nodes 204, 220, 222, 224 may operate independently except when communicating with another hardware node 204, 220, 222, 224. The story ID is passed along with the appropriate communications between the hardware nodes 204, 220, 222, 224. Thus, a respective one of the hardware nodes 204, 220, 222, 224 may have information about a sequence of events that only the respective one of the hardware nodes 204, 220, 222, 224 knows. Information about the sequence of events may be stored in the local storage element, such as storage element 226 on hardware node 224. Most of the time this information will never be used or accessed and will eventually be written over because there is nothing of interest in the information. However when something of interest does happen, such as an error, some local node will know about it, and this is the beginning of a “news event”.

For example, in the metaphor, someone robs a store and someone else witnesses the robbery. The person then reports it to the local authorities. This may be correlated with a chain of events that happened earlier in the day. Such a correlation produces a news story. A local reporter (such as reporter daemon 228 in hardware node 224), does not know anything about what happened earlier that day. Therefore, there is an event broadcast message 240 that goes out to all the local reporters on the other hardware nodes 204, 220, 222, 224. This message 240 may be sent, for example, by an application or software component 232 on the hardware node 224 to a reporter daemon 208 on hardware node 204. This message may ask, “Do you know anything about this event, and if you do, then report it to the editor (such as editor daemon 212 on hardware node 204)”. This event is tied together with the unique story ID. The editor daemon 212 is the only place where the big picture is known. The editor's function is to pull together all the local events into the complete news story 210.

On the hardware node 224 the software component 232 may be operatively coupled to the storage element 226 using log 236. Reporter daemon 228 may also be operatively coupled to the storage element 226 and exchange query 216 and records 248. The reporter daemon 228 may send specific reports 218 to the editor daemon 212.

The software implementations that define the local reporters, such as 228, may be predefined or may be configurable at any point during operation of the system.

For an occurrence of a broadcast event, a message 240 with a story ID goes to all the local reporters and tells them to collect everything they know about the event. Each reporter looks at its respective storage element, and sends any associated data (keyed by the story ID) to the editor 212. The editor 212 then coalesces all the information from the various hardware nodes 204, 220, 222, 224 into the news story 210.

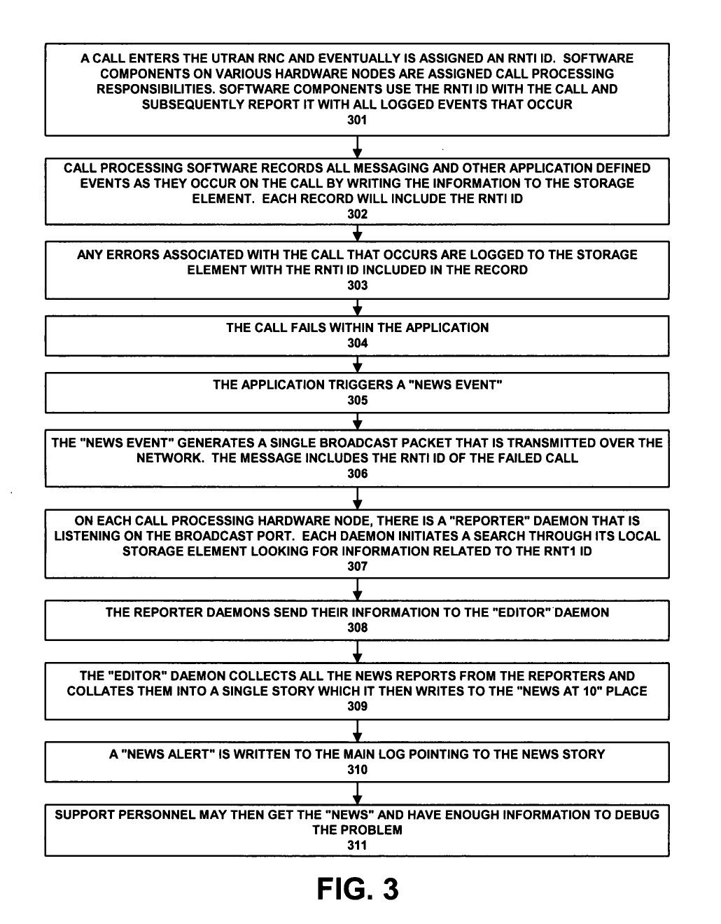

FIG. 3 depicts one embodiment of the present method. Terminology used in the FIG. 3 example is as follows:

UTRAN RNC refers to a boundary around a specific implementation, that is, it may define the system under observation.

The RNTI ID is analogous to the story ID.

API refers to an application processor interface.

This method embodiment may have the following steps:

1. (301) A call enters the UTRAN RNC and eventually is assigned an RNTI id. Software components on various hardware nodes are assigned call processing responsibilities. Software components use the RNTI id with the call and subsequently report it with all logged events that occur (logged events being existing error reports and other user defined events).

2. (302) Call processing software records all messaging and other application defined events as they occur on the call by writing the information to the storage element. Each record will include the RNTI id.

3. (303) Any errors associated with the call that occurs are logged to the storage element with the RNTI id included in the record.

4. (304) The call fails within the application.

5. (305) The application triggers a “news event”.

6. (306) The “news event” generates a single broadcast packet that is transmitted over the network. The message includes the RNTI id of the failed call.

7. (307) On each call processing hardware node, there is a “reporter” daemon that is listening on the broadcast port. Each daemon initiates a search through its local storage element looking for information related to the RNTI id.

8. (308) The reporter daemons send their information to the “editor” daemon.

9. (309) The “editor” daemon collects all the news reports from the reporters and collates them into a single story which it then writes to the “news at 10” place.

10. (310) A “news alert” is written to the main log pointing to the news story.

11. (311) Support personnel may then get the “news” and have enough information to debug the problem.

Clearly, embodiments of the present method and apparatus may include many variations on the above including the definition of many different types of other news story triggers. In fact, this functionality is really a superset of the computer program debug capabilities already in place. This feature may provide automatic collection and sorting of data that would otherwise need to be hunted down and sorted manually sometime after the fact.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a network having a plurality of interconnected nodes;
each of the nodes having a respective local reporter daemon and a storage operatively coupled thereto;
at least one of the nodes having an editor daemon;
an event broadcast message that is originated by a respective software component in a respective node in which an event occurred, the event broadcast message being sent to all local reporter daemons;
information related to the event stored in a respective storage of a respective node by a respective software component;
reports sent by the local reporter daemons to the editor daemon, the reports containing information related to the occurrence of the event; and
a news story formed by the editor daemon from the received information.

2. The apparatus according to claim 1, wherein the network is a telecommunication system.

3. The apparatus according to claim 1, wherein the news story contains information for use in debugging distributed real time telecommunication systems.

4. The apparatus according to claim 1, wherein the event is at least one of an error, a call failure, or an application defined event.

5. The apparatus according to claim 1, wherein the storage is a repository containing application defined events and data.

6. The apparatus according to claim 1, wherein the apparatus further comprises a story ID that is unique across the network, the story ID being assigned to the occurrence of the event.

7. The apparatus according to claim 6, wherein each item of the information related to the event stored in a respective storage of a respective node by a respective local reporter daemon is assigned the story ID.

8. The apparatus according to claim 6, wherein the editor daemon collects, edits and interleaves all information having the story ID to form the news story.

9. A method, comprising:
identifying an occurrence of an event in a system having a plurality of interconnected nodes with software components;
assigning a story ID that corresponds to the event;
attaching the story ID to all messages in the system that relate to the event, all software components storing the story ID while processing elements related to the event;
broadcasting, by a respective software component of a respective node in which the event occurs, the story ID to all other local reporter daemons in the system;
collecting information relative to the event by each of the local reporter daemons;
forwarding, by each of the reporter daemons, the collected information along with the story ID to an editor daemon on at least one of the nodes of the plurality of interconnected nodes; and
collecting, editing, and interleaving, by the editor daemon, the collected information and forming therefrom a news story that describes the occurrence of the event.

10. The method according to claim 9, wherein the system is a telecommunication system.

11. The method according to claim 9, wherein the news story contains information for use in debugging distributed real time telecommunication systems.

12. The method according to claim 9, wherein the event is at least one of an error, a call failure, or an application defined event

13. The method according to claim 9, wherein the collected information relative to the event is stored by each of the local reporter daemons in a repository containing application defined events and data.

14. The method according to claim 9, wherein the story ID is unique across the system.

15. The method according to claim 9, wherein each item of the information related to the event is stored in a respective storage of a respective node by a respective software component and is assigned the story ID.

16. A method, comprising:
identifying an occurrence of an event in a system having a plurality of interconnected nodes with local reporter daemons and reporting the event to a respective local reporter daemon of a respective node in which the event occurs, which corresponds to “when a newsworthy event occurs, dispatching a reporters to a respective area of the event”;
broadcasting, by a respective software component, a story ID to all local reporter daemons in the system, and forwarding, by each of the reporter daemons, collected information along with the story ID to an editor daemon on at least one of the nodes of the plurality of interconnected nodes, which corresponds to “through interviews and observations the reporters put together a set of facts that are collected into a news story”;
collecting, editing, and interleaving, by the editor daemon, the collected information, which corresponds to “the news story is sent to an editor for approval and modifications”; and
forming therefrom a news story that describes the occurrence of the event, which corresponds to “the news story is reported on the air”.

17. The method according to claim 16, wherein the system is a telecommunication system.

18. The method according to claim 16, wherein the news story contains information for use in debugging distributed real time telecommunication systems.

19. The method according to claim 16, wherein the event is at least one of an error, a call failure, or an application defined event.

20. The method according to claim 16, wherein the collected information relative to the event is stored by a software component in a repository containing application defined events and data.

21. The method according to claim 16, wherein the story ID is unique across the system.

22. The method according to claim 16, wherein each item of the information related to the event is stored in a respective storage of a respective node by a respective software component and is assigned the story ID.

23. The method according to claim 16, wherein as part of a reporting mechanism, the method further comprises providing controls to limit the number of events reported by the software component within a predetermined time interval, whereby the reporting mechanism protects the system from being overloaded when a series of reportable events occur simultaneously.

24. The method according to claim 23, wherein the predetermined time interval is a user specified time interval.
